(19) United States
(12) Patent Application Publication
(10) Pub. No.: US 2006/0141237 A1
(43) Pub. Date: Jun. 29, 2006

(54) Metal-ceramic materials

(76) Inventors: Katherine Leighton, Newark, DE (US); John Garnier, Newark, DE (US); Edgar Aleshire, Elkton, MD (US)

Correspondence Address: BLANK ROME LLP, 600 NEW HAMPSHIRE AVENUE, N.W., WASHINGTON, DC, 20037, US

(21) Appl. No.: 11/198,158

(22) Filed: Aug. 8, 2005

Related U.S. Application Data
(60) Provisional application No. 60/638,160, filed on Dec. 23, 2004.

(51) Int. Cl. C04B 35/56; B32B 5/14

(52) U.S. Cl. 428/307.7; 501/87

(57) ABSTRACT

A composite material that includes a ceramic with or without a fiber and a metal with the metal being magnesium, wherein the magnesium infiltrates the ceramic to form a continuous matrix, encapsulates the ceramic, or both infiltrates and encapsulates the ceramic or encapsulates the ceramic and fiber.

### RELATED APPLICATION

This application claims priority to U.S. Provisional Patent Application Ser. No. 60/638,160, filed Dec. 23, 2004, which is incorporated herein by reference.

### FIELD OF THE INVENTION

This invention relates to metal-ceramic composite material and bodies formed therefrom. Particularly, the invention relates to metal infiltrated and/or metal encapsulated ceramic materials, and ballistic armor structures produced therefrom. The present inventive composite materials provide high damage tolerance, multi-hit protective capability, light weight (i.e. aerial density of about 4 lb/ft² for standard SAPI armor), and relatively low cost, each of which is especially attractive for applications in lightweight armor.

### BACKGROUND OF THE INVENTION

In many armor applications, weight is not a critical factor, and thus traditional materials, such as steel, can offer some level of protection from ballistic projectiles and shell fragments. Steel armors also offer the advantage of low cost and can serve as structural members of the equipment into which they are incorporated. In recent decades, certain hard ceramic materials have been developed for certain armor applications. These ceramic-based armors, such as alumina, boron carbide, silicon carbide, and titanium diboride ceramics provide the advantage of being lighter in mass than steel (up to ⅓ density of steel) and provide higher ballistic stopping power as steel for the same mass. Thus, in applications in which having an armor design having the lowest possible mass is important, such as (human) body armor and aircraft armor, low specific gravity armor materials are highly desirable. Also, in ceramic armor, the lower the density, the greater the thickness of armor that can be provided for the same areal density. In general, a thick ceramic armor material is more desirable than a thinner one because a greater volume of the armor material will be engaged in attempting to defeat the incoming projectile. Moreover, the impact of the projectile on a thicker armor plate results in less tensile stress on the face of the plate opposite that of the impact than would result on the back face of a thinner armor plate. Thus, where brittle materials like ceramics are concerned, it is important to try to prevent brittle fracture due to excessive tensile stresses on the back face of the armor body; otherwise, the armor is too easily defeated. By preventing such tensile fracture, the kinetic energy of the projectile can be absorbed completely within the projectile, e.g. ideally causing complete projectile self-destruction at the surface of the armor body, or more typically, the kinetic energy absorption of the projectile manifests itself as the creation of a very large new surface area within the armor material in the form of a multitude of fractures, e.g., shattering of the ceramic while the projectile undergoes self-destruction as its kinetic energy goes to zero.

Current state-of-the-art body armor is the Small Arms Protective Insert (SAPI). The SAPI provides ballistic protection from specific 5.56 mm and 7.62 mm rounds when it is worn in the pocket of the appropriate tactical vest. The current SAPI, which includes both a ceramic strike face and a fiber reinforced plastic backing, weighs 5.1 lb/ft². Marines wear both a front and back plate, for a total of weight of about 11 pounds. Currently, field SAPIs can be made using a variety of materials including sintered alumina (Al₂O₃)), silicon carbide (SiC), boron carbide (B4C), or titanium diboride (TiB2) ceramic or hot pressed or reaction bonded ceramics, such as silicon carbide (SiC) or boron carbide (B₄C). Ballistic impact with the SAPI plate results in extensive fragmentation damage to the internal ceramic plate so that further ballistic protection is either seriously compromised or eliminated entirely necessitating use of additional textile fabric like Kevlar™ as a soft armor backing. In fact, occasional drops of the SAPI ensembles often result in breaking of the ceramic armor rendering the entire armor system ballistically degraded to the point of being inoperable. At this point, the SAPI ensembles are discarded and new inserts are required, resulting in considerable field replacement cost. For higher performance multi-hit applications, SAPI ensembles based on individual overlapped small tile or disc shaped mosaics can provide the necessary control to limit ballistic induced crack damage to single or adjacent tiles especially when multi-hit repeatability of less than 3 inches is needed. However, whether as single piece or tile mosaic, monolithic ceramics are still very brittle and therefore susceptible to breakage through occasional drops during general field use, also resulting in considerable field replacement as the unitized construction the entire plate must be replaced.

U.S. Pat. No. 6,862,970 to Aghajanian et al., which is incorporated herein by reference, discloses a composite having a boron carbide filler or reinforcement phase, and a silicon carbide matrix. The composite is produced by the reactive infiltration of an infiltrant having a silicon component with a porous mass having a carbonaceous component. The silicon component of the infiltrant reacts with the carbon of the porous mass to form silicon carbide as the matrix. The reaction Si+C→SiC also results in a local volumetric expansion of about 2%. This internal volumetric expansion can cause internal stresses in the composite leading to formation microcracks which will reduce mechanical properties of the composite as well as reducing ballistic impact resistance. Potential deleterious reaction of the boron carbide with silicon during the infiltration process step is suppressed by alloying or dissolving boron into the silicon prior to contact of the silicon infiltrant with the boron carbide. This is a complex process, especially in inhibiting the reaction between boron carbide and silicon.

U.S. Pat. Nos. 4,605,440 and 4,718,941 to Halverson et al. relate to an infiltration processing of B₄C, B and boron reactive ceramics using primarily aluminum metal as the infiltrant. Material compositions of B₄C with various metallic agents are produced with various powder sizes of B₄C and B selected for reaction rate and or alteration of surface chemistry to avoid non-desirable reactions with aluminum. To achieve a desirable final processed ceramic body, Halverson et al. demonstrates the need to reduce and/or eliminate residual free carbon to avoid “non desirable” by-product reactions such as aluminum carbide(Al+C→ARC) and to achieve “optimum” capillarity conditions for molten aluminum metal infiltration. Commercial B₄C particulate material used to make these composites typically contains significant amounts of residual free carbon up to 10 to 22-weight %.

In addition, internal reactions of various ceramic constituents with the metallic infiltrate results in consolidation of the green ceramic body resulting in shrinkage. Post processing of the ceramic by either sintering or using hot isocratic pressing further results in further shrinkage to as much as 16 to 20% from original green pressed body. Other infiltrated armor ceramics (e.g. silicon metal into silicon carbide or silicon metal into boron carbide) require high processing temperatures (e.g. melting temperature of silicon is about 1450° C.), which increase processing costs as well as generating internal stresses into the final composite as a direct result of cooling from the high processing temperature. Coefficient of thermal expansion of Si is higher than SiC and B₄C, cooling from high processing temperatures will result in residual internal stresses in the ceramic body. Residual tensile stresses in ceramic are known to generate microcracks which in turn reduce ballistic performance under high projectile impact. Therefore, it is desirable to process ceramics at lower temperatures to reduce the presence of residual stresses, thereby keeping microcracks to a minimum to achieve maximum ballistic performance for a given aerial density

Therefore, there remains a need for a lightweight armor having high damage tolerance and multi-hit protective capability that can be produced at relatively low cost.

### SUMMARY OF THE INVENTION

It is an object of the present invention to produce a composite material that has high damage tolerance, multi-hit protective capability, light weight (less than 2.45 g/cc), and relatively low cost.

It is an object of the present invention to produce a ballistic armor whose ballistic performance at least approaches that of commercially available ceramic armors at a lighter weight, lower cost, and/or higher durability in battlefield use.

It is an object of the present invention to produce a metal-ceramic composite where the metal infiltrates the non-continuous ceramic material to form a continuous metal phase.

It is an object of the present invention to produce a metal-ceramic composite material where the liquid metal encapsulates a ceramic material (non-continuous and/or continuous) and places the ceramic material under compression upon metal conversion to a solid after cooling from the liquid metal processing temperature.

It is an object of the present invention to produce a metal-ceramic composite where the metal infiltrates exterior edges of the ceramic material to form one or more metallic seams joining adjacent ceramic materials axially (e.g. having one or more laminate layers) or radically (e.g. having a frontal area greater than individual ceramic tiles) to form the ballistic armor.

It is an object of the present invention to produce a metal-ceramic composite where the metal infiltrates a preform placed between exterior edges of ceramic material to form one or more largely metallic seams joining adjacent ceramic materials axially (e.g. having one or more laminate layers) or radically (e.g. having a frontal area greater than individual ceramic tiles) to form a bonded ceramic body or axially (e.g. having outer perimeter metallic edge) to enable external edge attachment of the metal-ceramic composite by conventional means (e.g. bolt or weld).

It is an object of the present invention to produce a metal-ceramic composite material having a non-continuous or continuous coated fiber reinforced backing to enhance the stiffness of the ceramic material. The fiber can be carbon fiber, silicon carbide fiber or other ceramic fiber types such as alumina.

These objects and other desirable attributes of the present invention can be accomplished by providing a ceramic material and infiltrating and/or encapsulating the ceramic material and/or fiber backing with a metal. The ceramic material can be one or more types of ceramics and be shaped like a flat or curved tile (square, rectangular, hexagonal), consist of overlapping tiles and/or shaped like a beveled discus and/or contain regions of thicker or thinner ceramic materials for reasons of ballistic design and/or overlapping of finished units to avoid exposed joints. The preferred ceramic is boron carbide (B₄C); and the preferred metal is magnesium (Mg). The preferred fiber is carbon. In an embodiment, the metal preferably reacts with the ceramic material to form a chemical bond at the metal/ceramic interface. Moreover, when the metal encapsulates the ceramic material, it is preferred that the metal has a higher coefficient of thermal expansion (CTE) than the ceramic such that upon cooling from the high processing temperature the ceramic material as used at a much lower use temperature is maintained under constant compression by the metal. Compression will reduce, internal tensile stresses in the ceramic and thereby imparts superior multi-hit capability of the armor composite as locally fractured ceramic is locally constrained by the adjacent metal and/or exterior encapsulation metal.

### BRIEF DESCRIPTION OF THE DRAWINGS

FIG. 1a is a photograph showing the ballistic damage of a boron carbide tile;

FIG. 1b is a photograph showing the ballistic damage of encapsulated magnesium-boron carbide composite with carbon reinforcing fiber;

FIG. 1c is a photograph showing the ballistic damage of encapsulated magnesium-boron carbide composite;

FIG. 2 is a photograph of an encapsulated composite struck with a ball peen hammer; and

FIG. 3 is a photograph of an encapsulated composite including two ceramic layers and a metal bonding layer therebetween; and

### BRIEF DESCRIPTION OF THE PREFERRED EMBODIMENT

The present invention provides lightweight composite materials that have high impact damage tolerance and multi-hit protective capability, which can be produced at relatively low cost. The potential applications of the present composites include, but are not limited to, lightweight structures, cutting tools, hot and cool parts of turbine engines, impact resistant structures, abrasive and wear resistant and impact resistant materials, semiconducting devices, and armor.

In one embodiment, the material contains a ceramic preform infiltrated with a metal. The material is produced by the steps of placing the metal or its alloy on top of the ceramic, and heating to a temperature above the melting point of the metal. The molten metal then infiltrates the ceramic material and forms a continuous matrix in the pores of the ceramic material. After cooling and solidification, the result is a composite material of the present invention. Preferably, the process takes place in an inert environment having minimal oxygen content, preferably Argon.

In a second embodiment of the present invention, the ceramic material is reinforced with an adjacently placed fiber prior to infiltration by the metal. In this embodiment, the metal is melted over a layer of ceramic placed on the backing fibers to infiltrate into the ceramic and the backing fibers, thereby bonding the ceramic and the fiber being bonded together by the metal phase. The fibers can be in the back of the ceramic as well as in the front of the ceramic, or both. The fiber backing due to its higher strength, higher modulus and higher fracture toughness imparts to the metal-ceramic composite enhanced strength, stiffness and impact resistance (toughness) to the material. As a result of increased material strength, the ceramic composite can be made thinner further reducing weight while retaining bending strength. As a result of increased material stiffness, the aerial density of the composite can be reduced further reducing weight of the armor. As a result of increased impact resistance, the composite will be more resistant to incidental damage during use (e.g. resistance to breakage by casual dropping of the armor material). The reinforcing fiber can be, but is not limited to, titanium, tantalum, Ni-chrome, boron, silicon carbide, and carbon, with carbon being the preferred reinforcing fiber.

In a third embodiment of the present invention, the ceramic is enclosed within a metal encapsulation. This is particularly important in improving the multi-hit protective capability of the composite. In this embodiment, the metal encapsulation creates a reaction bond with the ceramic and places the ceramic under compression, which is achieved by selecting a metal that has a coefficient of thermal expansion (CTE) greater than that of the ceramic material. Magnesium has a nominal high CTE of 20 to 27×10-6 m/m/C as compared to typical ceramics ranging from a low CTE of 2 to 7×10-6 m/m/C. In this embodiment, the metal may or may not infiltrate the ceramic material; however, infiltration is preferred. For example, infiltration will occur if the ceramic contains open pores and/or the ceramic phase is non-continuous and/or the ceramic consists of dense mosaic tiles. Infiltration into the ceramic does not occur if the ceramic contains closed surface porosity i.e. solid.

Further, the encapsulation embodiment can also be used with a fiber-backed ceramic. In this case, both the ceramic material and the fiber are encapsulated and upon cooling from the processing temperature both the ceramic and the fiber will be under compression by the metal encapsulation, as the CTE of the metal is greater than the ceramic and the fiber. This compressive state will be maintained as long as the metal-ceramic composite operating state is kept below ca. ⅔ the melting point of the metal (e.g. 500 to 1000 C) as the melting point of the metal is generally ⅓ the melting point of the ceramic and/or fiber (e.g. 1700 C to 2200 C). Thus, the invention can be used in armor applications involving modest heat related applications, such as vehicle recipical engine compartments and certain locations on gas turbine engines, etc.

The thickness of the metal encapsulation is about 0.01 to about 1.25 inches thick, preferably about 0.03 to about 1.0 inch, and most preferably about 0.06 inch for armor. Preferably, the thickness of the metal encapsulation is uniform within ±20% or less. A uniform coating can be accomplished by placement of a uniformly thick sheet of metal between a graphite tool and the ceramic. Another method is to spray on a metal particulate coating of known thickness onto the surface of the ceramic and then place the metal-ceramic into a graphite tool. Because carbon is not a processing problem causing non-desirable metallic carbides when used with certain metals (e.g. magnesium), an organic binder can also be used to adhere the metal particles to the surface of the ceramic. The metal and ceramic in the graphite tool are processed in one-step by heating to the melting point of the metal then cooling back to room temperature. The tool maintains outside dimensions and the metal (as applied) fixes the thickness of the encapsulated layer. As needed, a thicker metal layer can be first one-step processed and using precision post machining, the encapsulated layer can be post machined to tight machining tolerances (±0.005 inches or better). The graphite tool is re-useable because carbon does not readily react with magnesium.

Further, the encapsulation embodiment can also be used to bond individual sections of ceramic tiles (e.g. same or combined) together with or without a fiber-backed ceramic. Again in this case, both the individual discrete ceramic materials, whether porous or solid, are encapsulated and put into compression by the metal encapsulation, as the CTE of the metal is greater than the ceramic and the fiber. The amount of compression placed onto the ceramic can be adjusted from positive to negative by varying the ratio of combined metal and fiber content in the metal encapsulation layer. For example: CTE Mg is nominal 20×10-6 m/m/C as compared to B4C nominal 3×10-6 m/m/C. B4C ceramic encapsulated by Mg metal will be under uniform axial and radial positive compression given a uniform encapsulation layer thickness. Combine Mg with carbon fiber (CTE ca. 1×10-6 m/m/C) at nominal 40-50 vol % carbon fiber and the resulting the Mg+C composite CTE is nearly the same as B4C resulting in a zero compressive state. At very high carbon loading in Mg the resulting encapsulated layer CTE is less than B4C, thus the B4C will under tension result in a decrease of both ballistic and impact durability of the ceramic. Furthermore, by adjusting either the Mg thickness and/or the ratio of Mg+C on the front ceramic face versus the back ceramic face, the ceramic frontal surface can be placed in net compression yielding potential additional performance benefits in frontal ballistic and impact.

Examples of ceramic materials appropriate for the present invention includes, but are not limited to, boron carbide (B₄C), silicon carbide (SiC), yittria stabilized zirconia, spinel, alumina (Al₂O₃), aluminum nitride (AlN), titanium diboride (TiB₂), and combinations thereof, with boron carbide being the preferred ceramic material. The ceramic material may be provided in a number of different morphologies, including particulates, platelets, flakes, whisker, continous fibers, microspheres, aggregate, etc. It is preferred that the ceramic material is in particulate form, especially powder, formed and pressed to form a ceramic preform prior to infiltration of the metal. Generally, higher green density is more desirable for higher final ceramic density leading to higher overall ballistic performance. The key to achieving higher green density is powder size and distribution. The powder blends in Table 1 are preferred for the present invention.

TABLE I
Cumulative Per Cent Finer Than (CPFT) at Micron Size Intervals

| Size | 500 grit | 800 grit | 1000 grit | 1200 grit | 10F pwdr |
|---|---|---|---|---|---|
| 15 | 1.1 | | | | |
| 10 | 9.6 | 2.7 | | | |
| 8 | 23.8 | 2.6 | 0.6 | | |
| 7 | 38.1 | 10.3 | 0.9 | | |
| 6 | 24.4 | 33.4 | 0.6 | | |
| 5 | 3 | 37.5 | 6.2 | | 1 |
| 4 | 0 | 7.6 | 55.8 | 5.3 | 11 |
| 3 | 0 | 2.5 | 34.1 | 79.9 | 60.6 |
| 2 | 0 | 1 | 1.8 | 13.2 | 24.5 |
| 1.5 | 0 | 2.3 | 0 | 1.6 | 2.9 |
| 1 | 0 | 0.1 | 0 | 0 | 0 |
| | 100 | 100 | 100 | 100 | 100 |

Prior to infiltration, the power is pressed in a hardened steel dye resulting in a preform, Binders can also be incorporated with the powder during the pressing process. The binders can be, but are not limited to, organic binders, such as polymethalmethacrylate (e.g. Elvacite™) which can cleanly burn off in the presence of an inert atmosphere (Argon) and if ay residue remains it is in the form of carbon.

The pressed preform is then bisque fired to remove volatile components and to impart strength, If desired, reinforcing fibers are assembled to the preform, preferably with fugitive glue (e.g. PMA) known to be compatible with the subsequent consolidation process. The fibers can be applied to or both sides of the preform. Other ceramic preforms are also appropriate, including pressureless sintered ceramics, such as pressureless sintered silicon carbide, pressureless sintered yittria stabilized zirconia, and pressureless sintered titanium diboride; and hot pressed ceramics, such as hot pressed boron carbide and hot pressed silicon carbide. Examples of metals appropriate for the present invention include, but not limited to, magnesium, zinc, silver, silicon, aluminum, cadmium, titanium and their respective alloys, and steel, with magnesium and magnesium alloys, such as Mg/Zn and Mg/Ag, being the preferred metal due to its inertness with carbon. The preform or fiber reinforced preform is laid up in a refractory box sized to fit closely around the preform. The metal or its alloy blocks are placed on top of the lay-up and heated in a controlled atmosphere, preferably Argon, to a temperature above the melting point of the alloy, typically in the range of 500° C. -1000° C., such as 700° C. for magnesium or magnesium alloys. The molten metal infiltrates the preform or the fiber reinforced preform. In the case of the fiber reinforced preform, the infiltrated metal also binds the ceramic preform and the reinforcing fibers. After cooling and solidification, the result is a high strength metal-ceramic composite.

For the encapsulation embodiment, excess metal is placed on the preform and melted at about 500° C.-1000° C., such as at 700° C. for magnesium or magnesium alloys, such that the metal also encapsulates and places the preform under compression. As disclosed above, to fix the thickness of the encapsulation layer, uniformly thick sheets of metal, spray on metal particles, or non-reactive spacing standoffs (e.g. made with carbon or non-reactive higher melting temperature metal) can be used. A non-reactive cloth, such as Al₂O₃, can be used to allow the metal to also penetrate into the ceramic material.

For both infiltration and encapsulation, it is preferred that the metal is melted at about 500°-1000°, such as at 700° C. for magnesium or magnesium alloys, which chemically bonds with the ceramic material to form the reaction bond. For example, when magnesium is used with boron carbide, a covalent bond between Mg and B forms (Mg+B₄C→MgB₂). This covalent bond is formed at the metal-ceramic interface to chemically bond the two phases together. Other magnesium/ceramic bonds that can form are: magnesium silicide (Mg+SiC→MgSi₂; magnesium diboride (Mg+TiB₂→MgB₂).

A second metal can also be used to encapsulate the encapsulated ceramic. For example, once the ceramic is encapsulated with magnesium (or magnesium alloy), as described above, the second metal can encapsulate the magnesium/ceramic encapsulation by a reaction bond, diffusion bond, or melt bond. The second metal can encapsulate substantially all of the magnesium/ceramic encapsulation, just a single side of the encapsulation, or just an edge or edges of the encapsulation. Various metals can be used as the second including magnesium, zinc, silver, silicon, aluminum, cadmium, titanium, their respective alloys, steel, and the like.

Without further description, it is believed that one of ordinary skill in the art can, using the preceding description and the following illustrative examples, make and utilize the compounds of the present invention and practice the claimed methods. The following examples are given to illustrate the present invention. It should be understood that the invention is not to be limited to the specific conditions or details described in these examples.

### EXAMPLE 1

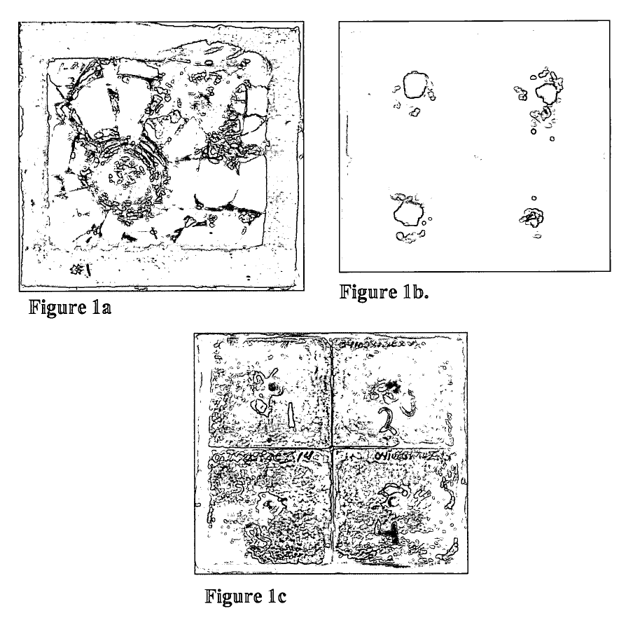

FIGS. 1a-c compare ballistic damage tolerance of hot pressed boron carbide (FIG. 1a), of encapsulated magnesium-boron carbide with carbon reinforcing fiber (FIG. 1b), and of encapsulated magnesium-boron carbide (FIG. 1c) with no carbon reinforcing fiber. Comparing FIGS. 1b and 1c to FIG. 1a shows the absence of apparent cracks in the composite tiles (FIGS. 1b and 1c) and the large number of cracks in the ceramic tile (FIG. 1a). Radial and circumferential cracks are nearly eliminated by the composite material, as shown in FIGS. 1b and 1c. Ballistic damage tolerance is improved by the supplemental procedure of wrapping and bonding carbon fibers onto the nonreinforced composite, as shown in FIG. 1b.

### EXAMPLE 2

Ballistic test data is shown in Table II. The three different tile reinforcement configurations tested gave acceptable ballistic results, i.e., the measured V₅₀ for each configuration was greater than the minimum of 2850 feet per second (fps) specified for SAPIs. The best result was a V₅₀ greater than 3122 fps using a composite weighing 4.6 pounds per square foot (encapsulated magnesium-boron carbide). This best result was obtained for a stratified composite of a balanced construction of an encapsulated magnesium-boron carbide tile reinforced with ceramic fibers on the front and back surfaces.

TABLE II

| Construction | V₅₀ (fps)* |
|---|---|
| Encapsulated magnesium-boron carbide reinforced with | >3122 |
| short ceramic fibers on both sides. | |
| Encapsulated magnesium-boron carbide reinforced with | 3025 |
| short ceramic fibers only on back (non-impact) side. | |
| Encapsulated magnesium-boron carbide reinforced with | 2950 |
| carbon fibers on both sides. | |

*V₅₀ is the projectile velocity at which the probability of stopping the projectile is 50%.

### EXAMPLE 3

Table 3 shows ballistic test results for two different encapsulated magnesium-boron carbides and a non-encapsulated magnesium carbide, each with same polymer fiber reinforcement setups.

TABLE III

| | | | | | Backing Bulge | Impact |
|---|---|---|---|---|---|---|
| Setup | Metal | Ceramic | Fiber Backing | Test Result | Height (in.) | Trauma |
| 1 | Mg 0.125 | Boron | 27 layers | Defeat 4 shots | 0.9 | Low |
| | in. thick | carbide | | | | |
| 2 | Mg 0.6 in. | Boron | 27 layers | Defeat 4 shots | 1.25 | Medium |
| | thick | carbide | | | | |
| 3 | None | Boron | 49 layers | Defeat 4 shots | 1.50 | Very high |
| | | carbide | | | | |

It clear from the result that the encapsulated composites are able to defeat ballistic impact with minimal impact trauma (e.g. reduced backing bulge) when compared to the ceramic without encapsulation.

### EXAMPLE 4

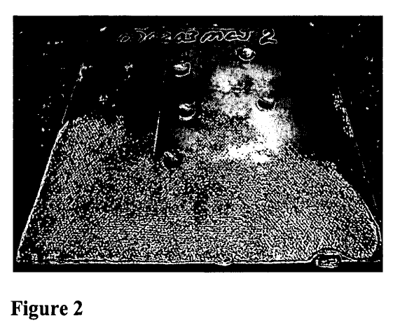

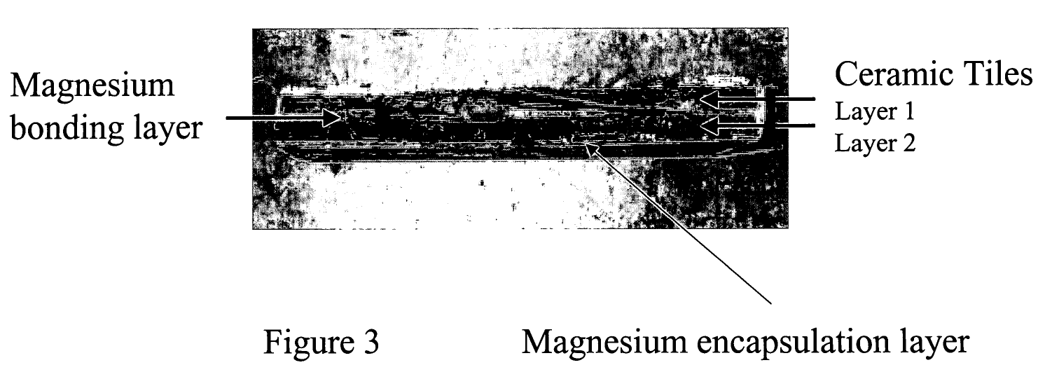

Improved resistance to damage by non-ballistic impacts was demonstrated for tiles of encapsulated magnesium-boron carbide composite. As shown in FIG. 2, five strikes with a ball peen hammer caused no apparent damage other than dimples in the metal encapsulation. A continental ceramic tile would instead shatter when struck with the hammer.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A composite material, comprising:
a ceramic; and
magnesium, wherein the magnesium infiltrates the ceramic to form a continuous matrix.

2. The composite material of claim 1, wherein the ceramic is boron carbide.

3. The composite material of claim 2, wherein the boron carbide is pressed powder.

4. The composite material of claim 1, wherein the ceramic is selected from the group consisting of silicon carbide, alumina, yittria stabilized zirconia, spinel, aluminum nitride, titanium diboride, and combinations thereof.

5. The composite material of claim 1, further comprising a fiber reinforcement.

6. The composite material of claim 5, wherein the fiber reinforcement is selected from the group consisting of carbon fiber, silicon carbide fiber, or a combination thereof.

7. The composite material of claim 1, wherein the ceramic and magnesium react to form a chemical bond.

8. A composite material, comprising:
a ceramic material; and
a metal, wherein the metal substantially encapsulates the ceramic material and places the ceramic material under compression.

9. The composite material of claim 8, wherein the coefficient of thermal expansion (CTE) of the metal is greater than the CTE of the ceramic material.

10. The composite material of claim 8, wherein the ceramic material is selected from the group consisting of boron carbide, silicon carbide, yittria stabilized zirconia, alumina, titanium diboride, and combinations thereof.

11. The composite material of claim 8, wherein the metal is selected from the group consisting of magnesium, zinc, silver, silicon, aluminum, cadmium, titanium and their respective alloys, and steel.

12. The composite material of claim 8, wherein the metal and the ceramic material react to form a chemical bond.

13. The composite material of claim 8, wherein the thickness of the metal encapsulation is about 0.01 to about 1.25 inches.

14. The composite material of claim 8, further comprising a fiber reinforcement.

15. The composite material of claim 14, wherein the fiber reinforcement is carbon fiber or silicon carbide fiber.

16. The composite material of claim 8, wherein the metal infiltrates the ceramic material.

17. The composite material of claim 8, further comprising a second metal that encapsulates at least a portion of the metal and ceramic material encapsulation.

18. The composite material of claim 17, wherein the second metal is selected from the group consisting of magnesium, zinc, silver, silicon, aluminum, cadmium, titanium and their respective alloys, and steel.

19. The composite material of claim 17, wherein the second metal bonds with the at least one portions of the metal and ceramic material encapsulation by any one of a reaction bond, diffusion bond, and melt bond.

20. A method for making a composite material, comprising the steps of:
providing a ceramic preform;
placing magnesium or magnesium alloy on the ceramic preform; and
heating the ceramic preform to allow the magnesium or magnesium alloy to infiltrate the ceramic preform.

21. The method of claim 20, wherein the ceramic preform is boron carbide.

22. The method of claim 21, wherein the heating step is accomplished at about 500° C.-1000° C.

23. The method of claim 20, further comprising the step of placing a fiber reinforcement adjacent to the ceramic preform.

24. The method of claim 23, wherein the fiber reinforcement is selected from the group consisting of carbon fiber, silicon carbide fiber, aluminum oxide fiber, and glass fiber.

25. The method of claim 20, wherein the ceramic preform and the magnesium or magnesium alloy react to form a chemical bond.

26. A method for making a composite material, comprising the steps of:
providing a ceramic body, the body being either porous or solid;
placing magnesium or magnesium alloy on the ceramic body; and
heating the ceramic body to allow the magnesium or magnesium alloy to substantially encapsulate the ceramic body.

27. The method of claim 26, wherein the heating step is accomplished at about 500° C.-1000° C.

28. The method of claim 26, further comprising the step of placing a fiber reinforcement adjacent to the ceramic body.

29. The method of claim 25, wherein the fiber reinforcement is selected from the group consisting of carbon fiber, silicon carbide fiber, aluminum oxide, and glass.

30. The method of claim 26, wherein the coefficient of thermal expansion (CTE) of the magnesium or magnesium alloy is greater than the CTE of the ceramic preform.

31. The method of claim 26, wherein the ceramic body is selected from the group consisting of boron carbide, silicon carbide, yittria stabilized zirconia, alumina, spinel, titanium diboride, and combinations thereof.

32. The method of claim 26, wherein the magnesium or magnesium alloy and the ceramic body react to form a chemical bond.

33. The method of claim 26, wherein the thickness of the metal encapsulation is about 0.01 to about 1.25 inches.

34. The method of claim 26, further comprising the step of controlling the amount of compression applied to the ceramic body by the metal encapsulation.

35. The method of claim 26, wherein the magnesium or magnesium alloy infiltrates the body.

36. The method of claim 26, further comprising the steps of placing a second metal on at least a portion of the magnesium or magnesium alloy and ceramic body encapsulation, and heating the second metal to form any one of a reaction bond, diffusion bond, or melt bond with the at least one portion of the magnesium or magnesium alloy and ceramic body encapsulation.

37. The method of claim 36, wherein the second metal is selected from the group consisting of magnesium, zinc, silver, silicon, aluminum, cadmium, titanium and their respective alloys, and steel.

38. A method of bonding two pieces of ceramic material, comprising the steps of:
providing at least two pieces of ceramic;
placing a metal between the two pieces of ceramic; and
heating the two pieces of ceramic to allow the molten metal to infiltrate or encapsulate the two pieces of ceramic.

39. The method of claim 38, wherein the heating step is accomplished at about 500° C.-1000° C.

40. The method of claim 38, wherein the coefficient of thermal expansion (CTE) of the metal is greater than the CTE of the pieces of ceramic.

41. The method of claim 38, wherein the ceramic is selected from the group consisting of boron carbide, silicon carbide, yittria stabilized zirconia, alumina, spinel, titanium diboride, and combinations thereof.

42. The method of claim 38, wherein the metal is selected form the group consisting of magnesium, zinc, silver, silicon, aluminum, cadmium, and their respective alloys.

43. The method of claim 38, wherein the metal and the pieces of ceramic react to form a chemical bond.

44. The method of claim 38, further comprising the step of:
placing a fibrous mat preform between the two pieces of ceramic, whereby the molten metal infiltrates the fibrous mat.

45. The method of claim 38, further comprising the step of:
providing a third piece of ceramic;
placing a second metal between the third piece of ceramic and one of the two pieces of previously infiltrated or encapsulated ceramic; and
heating the third piece of ceramic to allow the molten metal to infiltrate or encapsulate the third piece of ceramic.

46. The method of claim 38, further comprising the step of:
providing a third piece of ceramic;
placing a polymer between the third piece of ceramic and one of the two pieces of previously infiltrated or encapsulated ceramic; and
heating the third piece of ceramic to allow the molten metal to infiltrate or encapsulate the third piece of ceramic.
